(19) United States
(12) Patent Application Publication
(10) Pub. No.: US 2004/0169470 A1
(43) Pub. Date: Sep. 2, 2004

(54) Plasma display panel, back and front substrates for plasma display panel, and coated metal particle for forming electrode

(76) Inventor: Kazuyoshi Inoue, Sodegaura-shi (JP)

Correspondence Address: Parkhurst & Wendel, Suite 210, 1421 Prince Street, Alexandria, VA, 22314-2805, US

(21) Appl. No.: 10/477,186

(22) PCT Filed: Apr. 26, 2002
(86) PCT No.: PCT/JP02/04257

(30) Foreign Application Priority Data
May 14, 2001 (JP) 2001-142917

(51) Int. Cl. H01J 17/49; H01J 9/04

(52) U.S. Cl. 313/582; 313/491; 445/46

(57) ABSTRACT

In a plasma display panel, a back substrate has a first metal electrode on a back base substrate, and a front substrate has a transparent electrode and a second metal electrode on a front base substrate. The front substrate is arranged opposite to the back substrate. At least one of the first metal electrode and the second metal electrode being formed by e electrophotographic printing. At this time, coated metal particles are used as toner, which particles are formed by coating metal particles having an average diameter of 0.1 to 20 μm with thermoplastic resin. The electrophotographic printing enables manufacture of plasma display panels and the like with less waste of materials.

### TECHNICAL FIELD

This invention relates to a plasma display panel, front and back substrates, and coated metal particles for electrode formation.

### BACKGROUND ART

A need to reduce the volume and thickness of stationary displays has arisen in recent years owing to the increased size of the display plates. Various flat panel displays (thin-type displays) have been developed. Among these flat panel displays, the plasma display panel (PDP) achieves flat display on a large screen, light weight and reduced thickness, as well as a wide angle of visibility that enables the user to view the screen from almost totally sidewise angles. The plasma display panel is being utilized as an alternative to CRT picture tubes currently used in televisions and in this and other aspects has moved into the realm of practical application.

Fine metal wiring is required to increase the open area of the front substrate. Thus, in a conventional method of manufacturing a plasma display panel, sputtering and patterning steps are used to form the front substrate. In the sputtering step, a film is formed from various metals and metal oxides for electrodes using a vacuum device (sputtering device). In the patterning step, an electrode pattern is formed by photolithography.

However, these steps require complicated processes, and, particularly for the patterning step, resist application, exposure, etching and resist exfoliation must be repeated.

These steps for the formation of the front substrate therefore need to be simplified.

Further, in each of the steps, a large amount of energy is consumed due to the use of a vacuum device and repeated heating and cooling. The etching process needs a large amount of material. It is therefore desirable to reduce the amounts of materials and energy in the manufacturing steps.

In the formation of a front substrate, metal wiring can be also formed by screen printing. Since fine metal wiring is hard to obtain by this method, the open area of the front substrate is reduced.

Back substrate formation is subject to the same requirements as those of the front substrate since the same steps are performed.

Thus, a method for manufacturing a plasma display panel at low cost and energy with high utilization efficiency of materials is desired.

Japanese Patent Laid-open Nos. S59(1984)-189617, S59(1984)-202682, S60(1985)-137886 and S60(1985)-160690 teach formation of an electrode pattern from conductive particles by electrophotography followed by sintering.

However, since the conductive particles used in the technologies taught by these patent applications have a low resistance that may cause electric charge leakage, an electrode pattern with high accuracy cannot easily be printed. As a result, it has been difficult to reliably form conductive paths.

To solve this problem, Japanese Patent Laid-open No. H10(1998)-041066 teaches a method in which a conductive pattern is formed by electrophotography on a ceramic green sheet using developing agents containing insulative surface-treated metal particles and carrier particles.

This patent application makes no mention of forming a conductive pattern on members other than a ceramic green sheet, such as a base substrate for use in plasma display panels.

Through an intensive study, the inventors found that the above problem can be solved by printing an electrode wiring pattern on a base substrate by electrophotography using metal particles coated with thermoplastic resin and thereafter heating the resulting substrate at a certain temperature to decompose and evaporate the thermoplastic resin, thereby making the wiring pattern conductive.

Thus, an object of the present invention is to provide a plasma display panel, and front and back substrates for plasma display panels which can be efficiently manufactured with little waste of materials, and to provide coated metal particles for the formation of electrodes.

### DISCLOSURE OF THE INVENTION

According to one aspect of the present invention, there is provided a plasma display panel comprising: a back substrate that has a first metal electrode on a back base substrate, and a front substrate, arranged opposite to the back substrate, that has a transparent electrode and a second metal electrode on a front base substrate, at least one of the first metal electrode and the second metal electrode being formed by electrophotography.

According to another aspect of the present invention, there is provided a back substrate for a plasma display panel comprising a metal electrode formed by electrophotography.

According to another aspect of the present invention, there is provided a front substrate for a plasma display panel comprising a metal electrode formed by electrophotography.

In the above plasma display panel, and back and front substrates, desired fine wires of, for example, a width of about 10 to about 200 μm, preferably about 20 to about 100 μm, and a thickness of about 0.1 to about 2 μm, can be accurately formed, since the first and second metal electrodes are printed by electrophotography. It is therefore possible to achieve the high precision and narrow pitch required for substrates of plasma display panels.

Further, the electrophotographic printing reduces waste of materials and does not require a large amount of labor. In addition, printing by electrophotography can be applied in cases where various kinds but small amount of patterns are required.

In another aspect, the present invention provides coated metal particles for electrode formation comprising: metal particles whose average diameter is 0.1 to 20 μm, and a thermoplastic resin that coats the metal particles.

The coating of the metal particle with the thermoplastic resin makes the coated metal particles insulative, thereby enabling use of the insulate particles as toner in electrophotography.

The thermoplastic resin of the coated metal particles for electrode formation is preferably polyethylene type resin.

The polyethylene type resin can prevent adhesion in a developer and “spent” of carriers.

In the coated metal particles for electrode formation, the thermoplastic resin is preferably polymerized on the metal particle surface.

Polymerization of the resin on the particle surface enables uniform coating of the particles, and also makes it possible to change the thickness of the coating layer as desired.

The coated metal particles for electrode formation preferably comprise a metal selected from the group consisting of Sn, Ag, Pb, Bi, Cu, In, Ni, Zn, W, Ta, Mo, Al, Au and Cr, or an alloy of at least two elements selected from among the above group.

These metals and alloys are preferred from the viewpoint of resistance value, workability and cost. Ag and Cu are particularly preferable.

### BRIEF DESCRIPTION OF THE DRAWINGS

FIG. 1 is a sectional view of one embodiment of the plasma display panel according to the present invention.

FIG. 2 is a diagram showing an electrophotographic device for the formation of metal electrodes by using the coated metal particles according to the present invention.

### BEST MODE FOR CARRYING OUT THE INVENTION

The coated metal particles for the formation of electrodes (hereinafter referred to as “coated metal particles”) and the plasma display panel made using the particles according to the present invention will now be specifically described.

The coated metal particles according to the present invention each contains a metal particle and a thermoplastic resin coating the surface of the particle (resin coating layer).

1. Metal Particles

(1) Kind

The metal particles can be made of any conductive material with no limitation on kind. Materials for the metal particles include metallic elements selected from the group consisting of Sn, Ag, Pb, Bi, Cu, In, Ni, Zn, W, Ta, Mo, Al, Au and Cr, and alloys of at least two elements selected from among the above group. Preferred metals are Sn, Ag, Pb, Cu, W, Ta and Mo, and more preferred metals are Ag and Cu.

Preferred alloys are W alloys such as WTa and MoW, Al alloys, solders, and solder-free-alloys.

(2) Shape and Diameter

Metal particles of any shape such as spherical and irregular can be used without limitation. Spherical, e.g., uniform true spherical, is preferred.

The diameter of the metal particles is preferably 0.1 to 20 μm. If the diameter is smaller than 0.1 μm, the metal particles are liable to agglomerate when coated with thermoplastic resin and, when the particles are used as toner, the toner may scatter at the time of printing to lower the quality of the printed images.

If the diameter exceeds 20 μm, the particles cannot be readily used as toner. As a result, the quality of print images may be degraded and the electrode wiring may not be formed with high-accuracy.

For these reasons, the diameter is more preferably 0.2 to 10 μm, still more preferably 3 to 6 μm.

(3) Composition

The metal particles preferably account for 80 wt. % or more of the total coated metal particles. If they account for less than 80 wt. %, the coating layer becomes unnecessarily thick. This prevents the metal particles coming into close contact with each other at the time of printing an electrode wiring pattern, in which case sufficient conductivity may not be obtained after removal of the resin by heating. Further, the flowability of the metal particles decreases as the bulk density increases. This deceases the flowability of developing agents obtained by mixing them with carriers. As a result, the stability may be remarkedly lowered at the time of developing.

For these reasons, the metal particles more preferably account for 90 wt. % or more of the total coated metal particles.

There is no upper limit on the content of the metal particles insofar as the resin coating layer can completely cover the surface of the metal particles. In the case where the resin layer cannot completely cover the surface of the metal particles because the metal particle content is too large, insulating defects disadvantageously occur to degrade the printed images. The upper limit changes dependent on properties such as relative density and the geometry of the surface, and the diameter of the metal particles.

The metal particle content indirectly defines the thickness of the resin coating layer in the coated metal particles of the present invention.

2. Thermoplastic Resin

(1) Kind

There is no limitation on the kind of the thermoplastic resin. Usable thermoplastic resins include acrylic type resins and polyolefin type resins. Polyolefin type resins are preferable. More preferred resins are polyethylene resins that can be produced by direct polymerization on the surface of the metal particles. These thermoplastic resins will discompose and disappear at the sintering step after printing the electrode wiring, thereby imparting conductivity to the electrode wiring.

(2) Molecular Weight

In the case where a polyolefin type resin is used as a thermoplastic resin, monomers are preferably polymerized directly on the surface of the metal particles to produce a resin layer made of a high-molecular polyolefin. The high-molecular polyolefin preferably has a number average molecular weight of 2,000 or more or a weight average molecular weight of 10,000 or more.

The high-molecular polyolefin is different from polyethylene wax which are known as low-molecular polyethylenes, e.g., Mitsui high wax (Mitsui Chemicals, Inc.), San wax (Sanyo Chemical Co., Ltd.), Polyrez (neutral wax; Polymer Co., Ltd.), Dialene 30 (Mitsubishi Chemical Industries, Ltd.), Nisseki Lexpole (Nippon Oil Co.), Neowax (Yasuhara Chemical Co., Ltd.), AC polyethylene (Allied Chemical Inc.), Eporene (Eastman Kodak Company), Hoechst wax (Hoechst Inc.), A-Wax (BASF Ltd.), Polywax (Petrolite Inc.), Escomer (Exxon Chemical Co.) and the like. Polyethylene wax can be dissolved in heated toluene or the like and applied to the metal particles by means of an ordinary dipping or spray method. However, the polyethylene layers may peel from the surfaces of the metal particles owing to, for example, shearing forces arising in the developing device at the time of printing, since the mechanical strength of the resin is low. Thus, a polyolefin layer formed of polyethylene wax is not suitable for use in the present invention.

(3) Coating Amount

The metal particles are preferably coated with thermoplastic resin at a weight ratio of metal particles thermoplastic resin=99:1 to 80:20, more preferably 97:3 to 90:10.

3. Method of Producing Coated Metal Particles

(1) Method of Polymerizing Thermoplastic Resin on Metal Particles

For example, the metal particle surface is treated with a catalyst for olefin polymerization and olefin monomers are polymerized directly on the treated surface to form a resin coating layer.

Japanese Patent Laid-open Nos. S60(1985)-106808 and S60(1985)-106810 teach a polymerization method. Specifically, metal particles are pre-treated with a high activity catalyst component that contains titanium and/or zirconium and can be dissolved in a hydrocarbon solvent such as hexane or heptane. The pre-treated product and an organic aluminum compound are suspended in a hydrocarbon solvent. Olefin monomers are supplied to the suspension to be polymerized directly on the surfaces of the metal particles.

In this method, coatings obtained by the direct formation on the surfaces of metal particles have excellent strength.

Further, the direct formation can produce uniform coating layers, and any desired film thickness can be obtained by changing the amount of olefin.

(2) Flattening

The coated metal particles of the present invention can be subjected to flattening. The printing of the so-processed particles makes it possible to obtain wiring in which the particles contact each other more closely. The flattening method used can be optimally selected from among the following.

(a) Ball Mill Method

For example, to a 500 ml container are added a suitable amount of coated metal particles and ceramic balls of a diameter ten times that of the coated metal particles. The result is then mixed in a ball mill device for several tens of minutes. Thereafter the mixture is sifted using a screen of a mesh sufficiently smaller than that of the ceramic balls to remove the balls and obtain the flattened coated metal particles.

(b). Mixer Treatment

Coated metal particles are treated for several tens of minutes at in a mixer such as a Henschel mixer (Mitsui Mining Co., Ltd.) and Mechano mill (Okada Seiko Co., Ltd.) at a low rotation speed that does not deform the particles. Flattened coated metal particles can be obtained as a result.

(c) Heating Treatment

Coated metal particles are dispersed in an air flow by, e.g., using a thermal sphericallization machine (Hosokawa Micron Co.) The dispersed particles are rapidly heated to a temperature above the melting point of polyethylene and then rapidly cooled to be flattened without aggregation.

(d) Collision Treatment

Coated metal particles are flattened by being brought into collision with each other or a rotary blade using, e.g., a jet mill (counter jet mill, Hosokawa Micron Co.) and a hybridizer (hybridization, Nara Kikai Seisakusho).

(3) Method of Breaking Up Aggregates

Coated metal particles produced by direct polymerization form very weak aggregates which can be broken between the fingers at the time of filtering and drying. The aggregates can be broken up by subjecting them to oscillating sieving using a screen of 125 μm or less mesh in addition to the above flattening.

They may be also broken up by any method of applying shear stress to the particles such as by using a ribbon mixer or a Nauta mixer.

4. Insulating Property and Bulk Density of Coated Metal Particles

(1) Insulating Property

The coated metal particles are required to have a prescribed amount of charge to form developing agents and print electrode wiring by electrophotography. In the present invention, the metal particles are completely coated. An increase in the amount of the coating thermoplastic resin increases the insulating property of the coated metal particles.

The resistance value of the coated metal particles produced by the above method is too low to be measured by an ordinary powder resistance measuring method. For measuring the resistance of the coated metal particles, a layer of the coated metal particles with a thickness of 0.5 cm is formed between upper and lower electrodes in an electrode area of 5 cm² under a load of 1 kg. A voltage of 1 to 500 V is applied across the electrodes and the current passing through the bottom is measured to calculate the resistance. An ammeter with a lower measurement limit of 1 pA, i.e., that could not detect current lower than 1 pA, was unable to measure the resistance of any of the coated metal particles of the present invention.

(2) Bulk Density

According to the present invention, electrode wiring is printed by electrophotography and the wiring is thereafter baked to decompose and sinter the thermoplastic resin to form a substrate for a plasma display. This requires close contact of the coated metal particles. Further when the coated metal particles are temporarily fixed after the printing, the coating resin on the surface of the coated metal particles functions as a binder and becomes fixed. Thus, a suitable amount of resin is required, which amount changes depending on particle diameter and the like.

The bulk density of the coated metal particles of the present invention is about 1.0 to about 8.5 g/cc but changes dependent on the particle diameter and type of metal. The above-mentioned flattening treatment increases the bulk density. The bulk density is closely related to flowability. If the bulk density increases, the flowability of developing agents using the coated metal particles increases in proportion.

5. Developing Agent Containing Coated Metal Particles

(1) Carrier for Developing Agent

Electrode wiring can be printed in any of a 1, 1.5 or 2 component system. In view of charging and developing properties, the 2 component system is preferred where the toner is mixed with carriers to form a developing agent. Preferred carriers include magnetic powder such as ferrite, magnetite and iron powder; resin coated carriers obtained by coating carriers with resin; binder type carriers obtained by adding magnetic powder to resin; and polymerized coated carriers obtained by effecting polymerization directly on the surfaces of magnetic powder.

(2) Composition of Developing Agent

The coated metal particles of the present invention have five to ten times higher density than that of toners generally used in copying machines and printers. The ratio of general toners to carriers is 2 to 40 wt. %. In the case where the coated metal particles are used as two component developing agents, they are required to be mixed with carriers in a ratio of 10 to 400 wt. %.

6. Printing Machine and Method

(1) Printing Machine

In order to print electrode wiring with the coated metal particles of the present invention, the developing agent must be prepared in the above way. However, there is no limitation on the printing machine. Any machine capable of forming images by electrophotography, e.g., ONDEMAND printers as well as commercially available printers and copying machines, can be used. The polarity of the toner required changes between positive charge and negative charge dependent on whether the machine uses an amorphous silicon body system or an organic photosensitive body system. The required polarity can be imparted by properly selecting the specifications of the carriers or the type of charging roller.

Further, a machine must be modified, for example, to form space for receiving base substrates corresponding to the thickness thereof at the time of transfer. Additionally, the transfer system for base substrates must be one that does not soil the surfaces of the substrates or distort the substrates.

(2) Printing Method

Any printing among the 1, 1.5 or 2 component systems can be used so far as it uses the electrophotographic technique.

When, similarly to the case of using a printer, the printing data are supplied by a computer, the computer is first used to create the wiring diagram and printing is then conducted for the required number of copies. Identical metal wiring can be always obtained in this way. Unlike production of screens using a photoresist or screen printing process, which involves considerable expense, this way is free of problems such as the high cost and low stability encountered by the photoresist method.

7. Plasma Display Panel

In the plasma display panel of the present invention, the address electrodes and upper metal electrodes are printed by electrophotography. Parts other than the electrodes can be formed from ordinary materials by ordinary methods without any particular limitation.

[Embodiment 1]

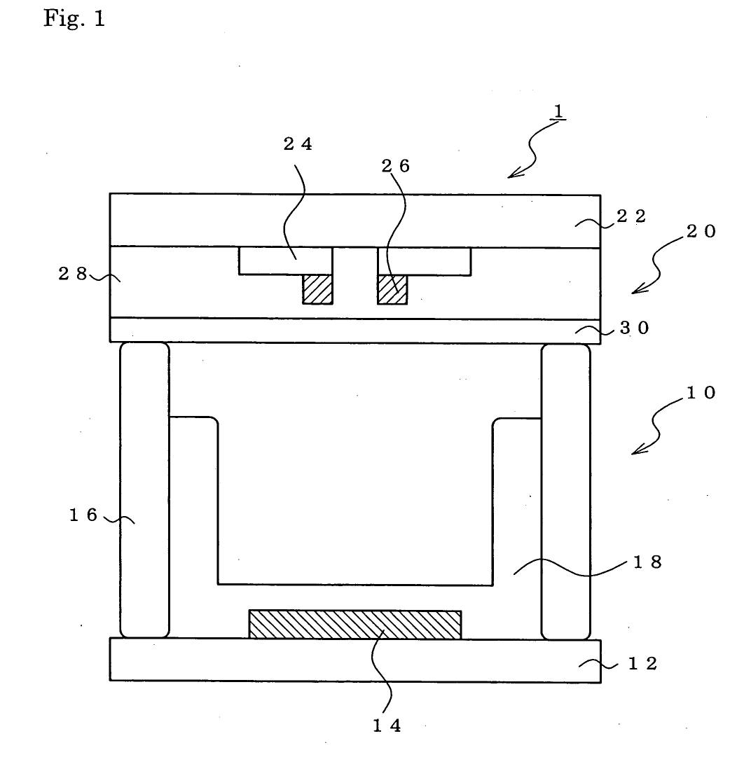

FIG. 1 is a sectional view showing one embodiment of the plasma display panel of the present invention. As shown in the drawing, a plasma display panel 1 is made of a back substrate 10 and a front substrate 20. The back substrate 10 comprises a back glass substrate (back base substrate) 12, a metal address electrode (first electrode) 14, a barrier wall 16 and a fluorophor 18. The front substrate 20 comprises a front glass substrate (front base substrate) 22, a transparent electrode 24, an upper metal electrode (second electrode) 26, a dielectric layer 28 and a protective layer 30.

A method of manufacturing the plasma display panel 1 will now be described with reference to FIG. 1.

First, the metal address electrode 14 is printed on the back glass substrate 12 by electrophotography as explained later. Thereafter the back glass substrate 12 with the metal address electrode 14 formed thereon is heated to 500 to 600° C. to decompose and remove the resin coating, thereby sintering the metal electrode.

The transparent electrode 24 is formed on the front glass substrate 22. The upper metal electrode 26 is then printed on the substrate 22 by electrophotography as explained later. The resulting substrate 22 is similarly heated to 500 to 600° C.

Then, the barrier wall 16 is formed on the back glass substrate 12 and the fluorophor 18 is disposed to produce the back substrate 10. The dielectric layer 28 and protective layer 30 are laminated on the front glass substrate 22 in this order to produce the front substrate 20. These substrates 10, 20 are adhered to each other to form the plasma display panel 1.

Next, a method of manufacturing the metal address electrode 14 and upper metal electrode 26 by electrophotography will be described.

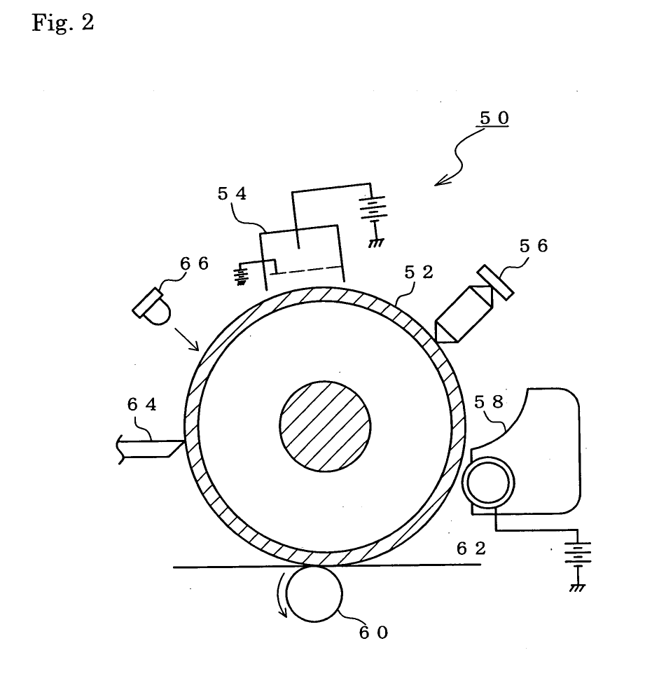

FIG. 2 is a diagrammatic view of an electrophotography apparatus 50 for the formation of the metal address electrode 14 and upper metal electrode 26 using coated metal particles. This apparatus 50 is an ordinary electrophotography apparatus in which a charging unit 54, an image signal exposure unit 56, a developing unit 58, a transfer roll 60, a cleaning blade 64 and a whole image exposure unit 66 are arranged around a photosensitive drum 52. A substrate 62 is provided between the photosensitive drum 52 and the transfer roll 60.

First, the charging unit 54 and image signal exposure unit 56 form an electrostatic latent image on the rotating drum 52. Next, the developing unit 58 supplies coated metal particles to form an electrode wiring image corresponding to the latent image. The transfer roll 60 then transfers the electrode wiring image to the surface of the substrate 62 (back glass substrate 12 or front glass substrate 22). The substrate 62 is heated to temporarily fix the electrode wiring. The substrate 62 is further heated and sintered so that the thermoplastic resin decomposes and the metal particles are sintered. The coated metal particles that were not transferred to the substrate 62 are removed by the cleaning blade 64.

### EXAMPLES

First a catalyst for polymerizing thermoplastic resin on metal particles was prepared.

### Reference Example 1

(1) Preparation of Catalyst Component Containing Titanium

To a 500 ml argon purged flask were added at room temperature 200 ml of dehydrated n-heptane and 15 g (25 mmole) of magnesium stearate that had been hydrated under reduced pressure (2 mmHg) at 120° C. to obtain a slurry. 0.44 g (2.3 mmole) of titanium tetrachloride was dropped into the slurry with stirring. Heating was then started. The reaction conducted under reflux for an hour yielded a viscous transparent solution of titanium-containing catalyst (active catalyst).

(2) Evaluation of Activity of Catalyst Component Containing Titanium

To a 1 liter argon purged autoclave were added 400 ml of dehydrated hexane, 0.8 mmole of triethylaluminum, 0.8 mmole of diethylaluminum chloride and 0.004 mmole as titanium atom of the titanium-containing catalyst prepared in (1). The mixture was heated to 90° C. At this time, the internal pressure of the system was 1.5 kg/cm²G. Hydrogen was supplied to increase the pressure to 5.5 kg/cm²G and ethylene was then continuously supplied so as to maintain the total pressure at 9.5 kg/cm²G. Polymerization for one hour yielded 70 g of polymer. The polymerization activity was 365 kg/g·Ti/Hr. The melt flow ratio (MFR) of the polymer obtained was 40 (190° C., load 2.16 kg: JIS K 7210).

Next, coated metal particles were produced using the catalyst prepared in Reference Example 1.

### Example 1

To a 2 liter argon purged autoclave were added 250 g of Ag particles (manufactured by Dowa Kogyo Co., average diameter 3 μm). The Ag particles were heated to 80° C. and dried for one hour under a reduced pressure (10 mmHg), followed by cooling to 40° C. Thereto was added 800 ml of dehydrated hexane and the mixture was stirred. Then 2.5 mmole of diethylaluminum chloride and 0.025 mmole as titanium atom of the titanium-containing catalyst prepared in (1) were added and the reaction was allowed to proceed for 30 minutes. Thereafter, the reaction system was heated to 90° C. and ethylene was continuously supplied so as to maintain the system internal pressure at 4.3 kg/cm²G until the total amount of ethylene, 13.2 g, was introduced. Polymerization for 10 minutes yielded 263.2 g of polyethylene coated Ag particles. The dried particles were uniformly gray. Observation under an electron microscope showed that the surfaces of the Ag particles were coated with a thin polyethylene layer. Measurement of the composite particles with a TGA (thermobalance) revealed that Ag particles:polyehtylene was 95:5. The composite particles were filtered, dried, and treated with an oscillating sieve of 53 μm mesh to produce coated metal particles A.

### Example 2

Coated metal particles B were obtained in a similar way to Example 1 except for substituting Cu particles (manufactured by Dowa Kogyo Co., 3 am) for the Ag particles.

### Example 3

Coated metal particles C were obtained in a similar way to Example 2 except for changing the diameter of the Cu particles from 3 μm to 6 μm.

### Example 4

Coated metal particles D were obtained in a similar way to Example 1 except for substituting In/Ag alloy particles (manufactured by Sinku Chikin Co., 2 μm) for the Ag particles.

### Example 5

The coated metal particles A were heated at 200° C. with a thermal sphere machine (Hosokawa Micron Co.) and rapidly cooled, thereby obtaining flattened coated metal particles E.

### Example 6

The coated metal particles A were treated by a hybridizer (Nara Kikai Kogyo Co., hybridization system) at 12,000 rpm for ten minutes, thereby obtaining flattened coated metal particles F.

### Example 7

To a universal mixing stirring machine were added 250 g of Ag particles (Dowa Kogyo Co., average diameter 3 μm), and further 500 ml of an acetone solvent and 2.53 g of styrene/acryl resin (MP5000, Soken Kagaku Co.). The mixture was stirred until the acetone solvent was evaporated. Crushing with a hybridizer and classification with a screen of 53 μm mesh gave coated metal particles G.

### Comparative Example 1

Coated metal particles H were obtained in a similar way to Example 7 except for using phenol resin (Asahi Yukizai Co.) and methyl alcohol as the resin and solvent.

### Comparative Example 2

Coated metal particles I were obtained in a similar way to Example 2 except for changing the diameter of the Cu particles from 3 μm to 25 μm.

[Evaluation Test 1]

The coated metal particles A to I were mixed with resin-coated carriers at a weight ratio of 20:100. Hydrophobic silica was added at an amount of 0.7 wt. % of the weight of the coated metal particles and mixed to obtain developing agents. In a commercially available printer (FS600, Kyocera Co.), developing agents set therein were replaced with the agents obtained. Printing was then carried out on various substrates made of paper, PET film, glass and polyimide and evaluated for background fog, density, fixing stability and clearness of fine lines. For the evaluation of background fog, the densities of white (non-printed) part and printed part on a printing surface were measured using a Macbeth illuminometer. For fixing stability, printed parts were rubbed with the fingers after printing and fixing steps, and removal of the printed parts was evaluated in five degrees: 5, no removal; to 1, complete removal. The clearness of fine lines was evaluated by printing a test pattern. The coated metal particles A to G of the present invention enabled good printing on all the substrates. The evaluation results for printing on paper are shown in Table 1.

TABLE 1

| | Background | Density | Fixing | Clearness of |
|---|---|---|---|---|
| | Fog (*1) | (*2) | Stability | Fine Lines (*3) |
| A | ◯ | ◯ | 5 | ◯ |
| B | ◯ | ◯ | 5 | ◯ |
| C | ◯ | ◯ | 5 | ◯ |
| D | ◯ | ◯ | 5 | ◯ |
| E | ◯ | ◯ | 5 | ◯ |
| F | ◯ | ◯ | 5 | ◯ |
| G | Δ | ◯ | 4 | ◯ |
| H | Δ | ◯ | 1 | ◯ |
| I | ◯ | X | 1 | X |

*1: ◯: No fog occurred. (Fog was not visually observed and the measured values were the same as those of white papers.) Δ: Little fog occurred. (Fog was not visually observed but the measured values were higher than those of white papers by 10% or more.) X: Fog occurred. (Fog was visually observed.)
*2: ◯: No differences in density were observed. X: Differences in density were observed.
*3: ◯: Fine lines spaced 100 mμ apart were distinct. X: Fine lines spaced 100 μm apart were not distinct and some parts of the lines contacted each other.

[Evaluation Test 2]

The coated metal particles A to I were mixed with resin coated carriers at a weight ratio of 20:100. To the mixture was further added and mixed 0.7 wt. % of hydrophobic silica relative to the weight of the coated metal particles, thereby preparing developing agents. In a commercially available printer (FS600, Kyocera Co.), developing agents set therein were replaced with the agents obtained. Fine wires with a width of 100 μm were then printed on a glass. The glass with the fine wiring thereon was temporarily fixed at 180° C. and sintered at 600° C. Conductivity was confirmed.

TABLE 2

| | Metal Particle | | | | | | | | |
|---|---|---|---|---|---|---|---|---|---|
| | A | B | C | D | E | F | G | H | I |
| Resistance | ◯ | ◯ | ◯ | ◯ | ◯ | ◯ | Δ | X | X |

◯: Conductivity was confirmed.
Δ: Conductivity was confirmed but resistance was significantly increased.
X: No conductivity

### INDUSTRIAL UTILITY

The present invention provides a plasma display panel, and front and back substrates for plasma display panels, that can be efficiently manufactured with little waste of materials, and also provides coated metal particles for the formation of electrodes.

What is claimed is:

1. A plasma display panel comprising:
a back substrate that has a first metal electrode on a back base substrate, and
a front substrate, arranged opposite to the back substrate, that has a transparent electrode and a second metal electrode on a front base substrate,
the first metal electrode and/or the second metal electrode being formed by electrophotography.

2. A back substrate for a plasma display panel comprising a metal electrode formed by electrophotography.

3. A front substrate for a plasma display panel comprising a metal electrode formed by electrophotography.

4. Coated metal particles for electrode formation comprising:
metal particles whose average diameter is 0.1 to 20 μm, and
a thermoplastic resin which coats the metal particles.

5. Coated metal particles for electrode formation in accordance with claim 4, wherein the thermoplastic resin is polyethylene type resin.

6. Coated metal particles for electrode formation in accordance with claim 4, wherein the thermoplastic resin is formed by polymerization on the surface of the metal particles.

7. Coated metal particles for electrode formation in accordance with claim 5, wherein the polyethylene type resin is formed by polymerization on the surface of the metal particles.

8. Coated metal particles for electrode formation in accordance with any one of claims 4 to 7, wherein the metal particles comprise a metal selected from the group consisting of Sn, Ag, Pb, Bi, Cu, In, Ni, Zn, W, Ta, Mo, Al, Au and Cr, or an alloy of at least two elements selected from the above group.
